(19) United States
(12) Patent Application Publication
(10) Pub. No.: US 2026/0238234 A1
(43) Pub. Date: Aug. 13, 2026

(54) MULTI-MODE WIRELESS RADIO TRANSCEIVER DEVICE

(71) Applicant: Infineon Technologies AG, Neubiberg (DE)

(72) Inventors: Daniel Lee, Salt Lake City, UT (US); Kameswara Medapalli, Saratoga, CA (US); Claudio Rey, Chandler, AZ (US)

(21) Appl. No.: 19/052,349

(22) Filed: Feb. 13, 2025

(51) Int. Cl. H04B 1/00; H04B 1/40

(52) U.S. Cl. CPC H04B 1/0003; H04B 1/40

(57) ABSTRACT

Some aspects of the present disclosure relate to a multi-mode wireless-communication integrated circuit (IC) with multiple optimized blocks that can be reconfigured, interconnected, enabled and disabled in a programable manner to allow support of multiple protocols, modulations and modes. These blocks can include low-noise amplifiers, power amplifiers, mixers, programmable local oscillators, programmable filters, programmable analog-to-digital converters (ADCs), programable digital-to-analog converters (DACs), a plurality of types of modulators and demodulators, additional digital circuitry, that can include predefined blocks as wells as FPGAs. Wherein the selective enabling and disabling, the setting of operating parameters, programable interconnecting and programming correspond to a selected operating mode of a plurality of operating modes.

### BACKGROUND

Progressing consumer and commercial wireless communication technology has seen the introduction and development of various wireless radio-frequency communication technologies. For example, ultra-wideband (UWB) 802.15.4z, Bluetooth (a registered trademark of Bluetooth SIG, Inc.), and 802.15.4 systems are used in various short-range wireless communication applications, such as, for example, Internet of Things (IoT), household, automotive, commercial, and industrial applications. While these systems share some similarities, such as, for example, generally operating in unlicensed radio-frequency bands, each has distinct operating characteristics that require specialized corresponding hardware for efficient operation.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates a simplified schematic of an example integrated circuit (IC) device in accordance with an embodiment of the disclosure.

FIG. 2 illustrates a simplified schematic of an example implementation of an IC device in accordance with an alternative embodiment of the disclosure.

FIG. 3 shows the SoC of FIG. 1 operating in a Bluetooth receive operating mode.

FIG. 4 shows the SoC of FIG. 1 operating in a Bluetooth low-power receive operating mode.

FIG. 5 shows the SoC of FIG. 1 operating in a 802.15.4 Zigbee receive operating mode.

FIG. 6 shows the SoC of FIG. 1 operating in a Bluetooth transmit operating mode.

FIG. 6A shows the SoC of FIG. 1 operating in a Bluetooth low-power transmit operating mode.

FIG. 7 shows the SoC of FIG. 1 operating in a 802.15.4 Zigbee transmit operating mode.

FIG. 8 shows a flowchart for an example procedure for embodiments of the disclosure.

### DETAILED DESCRIPTION

The present disclosure will now be described with reference to the attached drawing figures, wherein like reference numerals are used to refer to like elements throughout, and wherein the illustrated structures and devices are not necessarily drawn to scale.

Short-range wireless communication offers numerous benefits for consumer and commercial applications. Accordingly, there has been a proliferation in short-range wireless communication systems for consumer and commercial applications. While, theoretically, the entire radio-frequency range may be available for such systems, transmission in many radio-frequency bands requires a government license in order to avoid interference in those bands. There are, however, several unlicensed radio-frequency bands that are generally available for use without obtaining a license. Systems operating in those unlicensed bands may, however, be restricted in their transmission power in order to reduce interference with other systems. Various other techniques may also be employed to reduce interference among multiple neighboring systems operating in the same radio-frequency band. For examples, systems might check that a channel is free before using it, or might hop across a number of channels to reduce overall interference. The particular radio-frequency bands available for unlicensed use may vary by country. However, some bands are fairly universally available for unlicensed use, such as, for example, the 2.4GHz Industrial Scientific and Medical (ISM) band.

Electronics manufacturers have developed multiple standards for short-range wireless communication, geared for particular markets. Note that short range, as used herein, refers to wireless communication links generally no farther than a couple of hundred meters. Note, further, that while individual nodes may be no more than a couple of hundred of meters apart, multiple nodes may form mesh networks of unlimited size. Among the more popular short-range wireless communication standards are the above-noted Bluetooth, UWB 802.15.4z, and 802.15.4 Zigbee standards.

These standards not only differ from each other, but as each standard evolves, any particular standard may have multiple differing versions itself. Conventional devices that use a particular short-range wireless communication standard use hardware optimized for that standard, which is not only incompatible with the other standards, but may also be incompatible with future iterations of an evolving standard. Software defined radios implement some radio-communication functions, such as filtering, modulation, and demodulation, in software and, as a result, offer some flexibility in implementing multiple standards and allow for evolving standards via software updates. However, a drawback of using software to implement those radio-communication functions is reduced speed and operational efficiency. A modular radio hardware system can offer both flexibility for implementing multiple communication standards while maintaining speed and operational efficiency. Relatedly, a modular radio hardware system can support both narrowband (e.g., FM) and wideband (e.g., UWB) communication systems using shared hardware components of a single device.

As noted, Bluetooth, UWB 802.15.4z, Zigbee 802.15.4, and other short-range wireless communication systems share some common components. On the receive path, these systems use an antenna, a low-noise amplifier (LNA), one or more mixers, frequency filters, analog-to-digital converters (ADCs), a corresponding demodulator, and additional digital circuitry (e.g., additional baseband modem circuitry). On the transmit path, these systems use the additional digital circuitry, a corresponding modulator, one or more digital-to-analog converters (DACs), frequency filters, and mixers, a power amplifier (PA), and an antenna. Some of these components (e.g., components of the baseband modem) may be shared by both the transmit and receive paths.

In some embodiments of the disclosure, a programmable system on a chip (SoC) device implements a multi-mode wireless-communication system. The device includes a plurality of controllably connectable component blocks such as ,for example, a low-noise amplifier, a power amplifier, mixers, a programmable local oscillator, programmable filters, programmable analog-to-digital converters (ADCs), programmable digital-to-analog converters (DACs), a plurality of types of modulators and demodulators, additional baseband modem digital circuitry, and a mode controller. The mode controller is configured to selectively interconnect, enable, and disable one or more of the mixers, the local oscillator, the programmable filters, the programmable ADCs, the programmable DACs, the modulators, and the demodulators, set the operating parameters of the local oscillator, program the programmable filters, and program the ADCs, wherein the selective enabling and disabling, the setting of operating parameters, and programming correspond to a selected operating mode of a plurality of operating modes.

Bluetooth systems, for example, use frequency hopping in the 2.4GHz ISM band, transmitting at relatively low power, to connect peripheral devices, provide point-to-point connectivity, as well as for other purposes. Impulse-Radio Ultra-Wide-Band (IR-UWB) is a low-power wireless near-field communication technology that uses numerous very short and narrow radio-frequency electromagnetic pulses transmitted over a wide frequency band. Typically, the transmitted pulses are shorter than 2 ns and the corresponding bandwidth is in the neighborhood of 500 MHz or more. In addition to being useful for communication, the shortness and narrowness of the transmitted pulses also allow for an accurate calculation of distances between transceivers by, for example, using two-way ranging. Zigbee 802.15.4 is a wireless communication protocol designed for low-power and low-data-rate mesh networks, such as home automation systems.

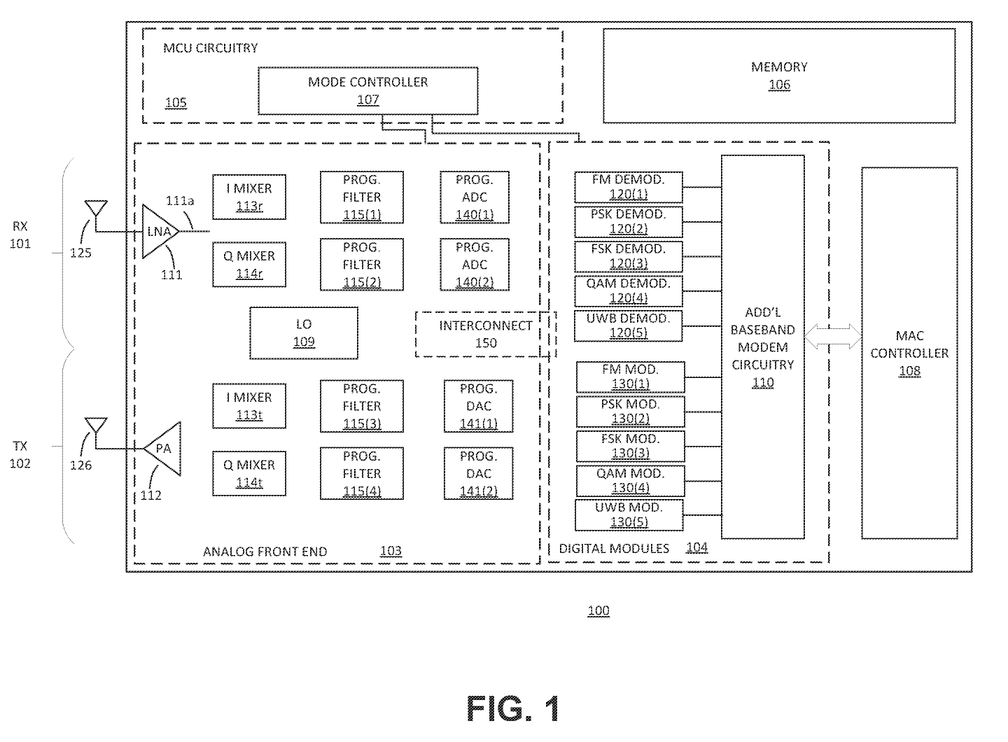

FIG. 1 illustrates a simplified schematic of an example integrated circuit (IC) device 100 in accordance with an embodiment of the disclosure. IC device 100 may be implemented as a programmable system on a chip (SoC) device. SoC 100 comprises microcontroller (MCU) circuitry 105, memory 106, medium-access-control (MAC) controller 108, digital modules 104, analog front-end 103, and antennas 125 and 126. The MCU circuitry, which may include one or more processor cores (e.g., CPUs) (not shown), includes a mode controller 107.

The memory 106 is a random-access memory (RAM) accessible by at least the MCU circuitry 105. The memory 106 may comprise, for example, one or more of static RAM (SRAM), resistive RAM (RRAM), and non-volatile RAM (NVRAM). The MCU circuitry 105 may also access external RAM (not shown) such as, for example, dynamic RAM (DRAM).

The MAC controller 108 manages digital data framing, medium access, and communication protocols for the SoC 100. The MAC controller 108 provides digital data for transmission to, and receives processed (e.g., frequency-limited and digitized) digital data from, the digital modules 104. The digital modules 104 include a plurality of demodulators 120, modulators 130, and additional baseband modem circuitry 110. The digital modules 104 convert between demodulated digital data for/from the MAC controller 108 and modulated digital versions of the data from/for analog-to-digital converters (ADCs) 140 and analog-to-digital converters (DACs) 141. The digital modules 104 may also be said to convert between packetized and streaming, or serial, data.

The digital modules 104 include a plurality of types of hardware modulators and corresponding demodulators, where each may be configured for a particular type of data modulation. Modulation types may include any of the following schemes: frequency modulation (FM), frequency-shift keying (FSK), phase-shift keying (PSK), binary PSK (BPSK), differential PSK (DPSK), quadrature PSK (QPSK), offset QPSK (OQPSK), orthogonal frequency-division multiplexing (OFDM), impulse-radio ultra-wide-band (IR-UWB), and quadrature amplitude modulation (QAM). The digital modules 104 of FIG. 1 include FM demodulator 120(1), PSK demodulator 120(2), FSK demodulator 120(3), QAM demodulator 120(4), UWB demodulator 120(5), FM modulator 130(1), PSK modulator 130(2), FSK modulator 130(3), QAM modulator 130(4), and UWB modulator 130(5). It should be noted that in some implementations, the PSK modulator 130(2) and PSK demodulator 120(2) may implement one or more of PSK, BPSK, DPSK, QPSK, OQPSK, and other PSK modulation schemes.

Each modulator 130 can be configured to connect to one or more components of the analog front end 103, such as, for example, one of the programmable DACs 141, a local oscillator (LO) module 109, or a power amplifier (PA) 112. Each demodulator 120 can similarly be configured to connect to one or more components of the analog front end 103, such as, for example, programmable ADCs 140. The demodulators 120 and modulators 130 may controllably connect to selected components of the analog front end 103 using an interconnect 150. The interconnect 150 reconfigurably interconnects components of the analog front end 103 and digital modules 104 and may comprise, for example, crossbar switches, switch matrices, interconnect fabrics, or any other suitable selectively controllable or programmable interconnect technology. Note that the interconnect 150 may include a combination of reconfigurable and static connections. For example, the modulators 130 may be connected to analog front end components with configurable connections while being connected to the additional baseband modem circuitry 110 with static connections.

The analog front end 103 comprises, in addition to the above-mentioned interconnect 150, programmable ADCs 140 and DACs 141, local oscillator (LO) module 109, and power amplifier (PA) 112, in-phase mixers (I-mixers) 113, quadrature mixers (Q-mixers) 114, programmable filters 115, and a low-noise amplifier (LNA) 111. The LNA is connected to an antenna 125, while the PA is connected to an antenna 126. The interconnect 150, as well as other components of the device 100, may include field-programmable gate arrays (FPGAs) for configuring desired capabilities and features.

Some components of the SoC 100 may be configured to be part of a receive path 101, some components may be configured to be part of a transmit path 102, and some components may be configured to be shared by both the receive path 101 and the transmit path 102. Note that modules configured to be part of a receive path in a first configuration may be reconfigured to be part of a transmit path in a second configuration. On the receive path 101, the antenna 125 receives a radio signal and converts it to an electrical signal provided to the LNA 111, which amplifies the signal and outputs corresponding output signal 111a to I-mixer 113r and Q-mixer 114r. The I-mixer 113r and Q-mixer 114r receive a suitable oscillating signal from the LO module 109 to mix with the signal 111a to generate corresponding baseband frequency signals for provision to corresponding programmable filters 115. A suitable oscillating signal may be at the carrier frequency of the radio signal. The oscillating signal used by the Q-mixer 114r is 90 degrees (or π/2 radians) out-of-phase with the oscillating signal used by the I-mixer 113r. In some implementations, the Q-mixer 114r includes circuitry to phase-shift the oscillating signal from the LO module 109 by 90 degrees. In some implementations, the LO module 109 provides two oscillating signals that are 90 degrees out of phase, one to the I-mixer 113r and the other to the Q-mixer 114r. A signal provided by the LO module 109 may be referred to as a local-oscillator signal.

The I-mixer 113r provides its output mixed signal to the programmable filter 115(1) and the Q-mixer 114r provides its output mixed signal to the programmable filter 115(2). The programmable filters 115 may be configured as low-pass or band-pass filters to filter out unwanted frequencies in the mixed signal outputs of the mixers (e.g., I-mixer 113r and Q-mixer 114r) and provide an output signal in a desired frequency range (e.g., at the baseband frequency) to the corresponding programmable ADC 140 (e.g., ADCs 140(1) and 140(2)). Filter 115(1) provides its filtered output signal to ADC 140(1) and filter 115(2) provides its filtered output signal to ADC 140(2). Each ADC 140 converts its received input analog signal into a corresponding modulated digital signal. Each ADC 140 may be configured to selectively connect to, and provide its modulated digital signal output to, each and any demodulator 120. For example, ADC 140(1) may be configured to selectively connect to any of FM demodulator 120(1), PSK demodulator 120(2), FSK demodulator 120(3), QAM demodulator 120(4), and UWB demodulator 120(5). It should be noted that some configurations may bypass the ADCs 140 and/or other received path 101 components. For example, in some configurations, the UWB demodulator 120(5) may be connected to receive the output of a programmable filter 115, an I-mixer 113, a Q-mixer 114, or LNA 111. The demodulators 120 are configured to demodulate their received modulated input and provide corresponding demodulated data to the MAC controller 108 via the additional baseband modem circuitry 110. Generally, only one type of demodulator 120 or modulator 130 would be enabled in any particular operating mode.

The transmit path 102 is somewhat a reverse of the above-described receive path 101. Any of the modulators 130—namely, FM modulator 130(1), PSK modulator 130(2), FSK modulator 130(3), QAM modulator 130(4), and UWB modulator 130(5)—may be configured to receive demodulated data from the MAC controller 108 via the additional baseband modem circuitry 110. Each modulator 130 is configured to modulate received demodulated data into a modulated digital signal at the baseband frequency, in accordance with the modulation scheme of the particular modulator 130. The output of any particular modulator 130 may be provided to, for example, one of the programmable DACs 141 (e.g., DAC 141(1) and DAC 141(2)), to the LO module 109, an I-mixer 113, a Q-mixer 114, or the PA 112. For example, any of the FM modulator 130(1), the PSK modulator 130(2), the FSK modulator 130(3), and the QAM modulator 130(4) may be configured to connect to the LO module 109 to directly control its output frequency. As another example, any of the QAM modulator 130(4) and the UWB modulator 130(5) may be configured to connect to a mixer 113, mixer 114, or the PA 112 to directly control the output signal. Any other suitable configuration is also available using the interconnect 150.

Each DAC 141 is configured to convert the received modulated digital signal into a corresponding analog output signal for provision to the corresponding transmission mixer (e.g., I-mixer 113t or Q-mixer 114t) via the corresponding filter 115. The DAC 141(1) provides its output to the I-mixer 113t via filter 115(3), while the DAC 141(2) provides its output to the Q-mixer 114t via filter 115(4). As noted above, the filters 115 remove portions of their input signal in unwanted frequencies to provide an output signal in the desired frequency range (e.g., at the baseband frequency).

The transmit I-mixer 113t and Q-mixer 114t are configured to receive a suitable oscillating signal from the LO module 109 to mix with their input signals to generate corresponding carrier-frequency signals for provision to the power amplifier 112. A suitable oscillating signal may be at the carrier frequency of the intended radio signal. The oscillating signal used by the Q-mixer 114t is 90 degrees out of phase with the oscillating signal used by the I-mixer 113t. In some implementations, the Q-mixer 114t includes circuitry to phase-shift the oscillating signal from the LO module 109 by 90 degrees. In some implementations, the LO module 109 provides two oscillating signals that are 90 degrees out of phase, one to the I-mixer 113t and the other to the Q-mixer 114t. Note that a generic configurable mixer module may be configured to function as any of mixers 113r, 114r, 113t, and 114t.

The LO module 109, as well as some of the additional baseband modem circuitry 110, and the MAC controller 108 are shared by both the receive path 101 and the transmit path 102. As described elsewhere herein, other elements may be shared as well. For example, in some implementations, components of the mixers, filters, ADCs, DACs, modulators, and demodulators might also be shared by both the receive path 101 and the transmit path 102.

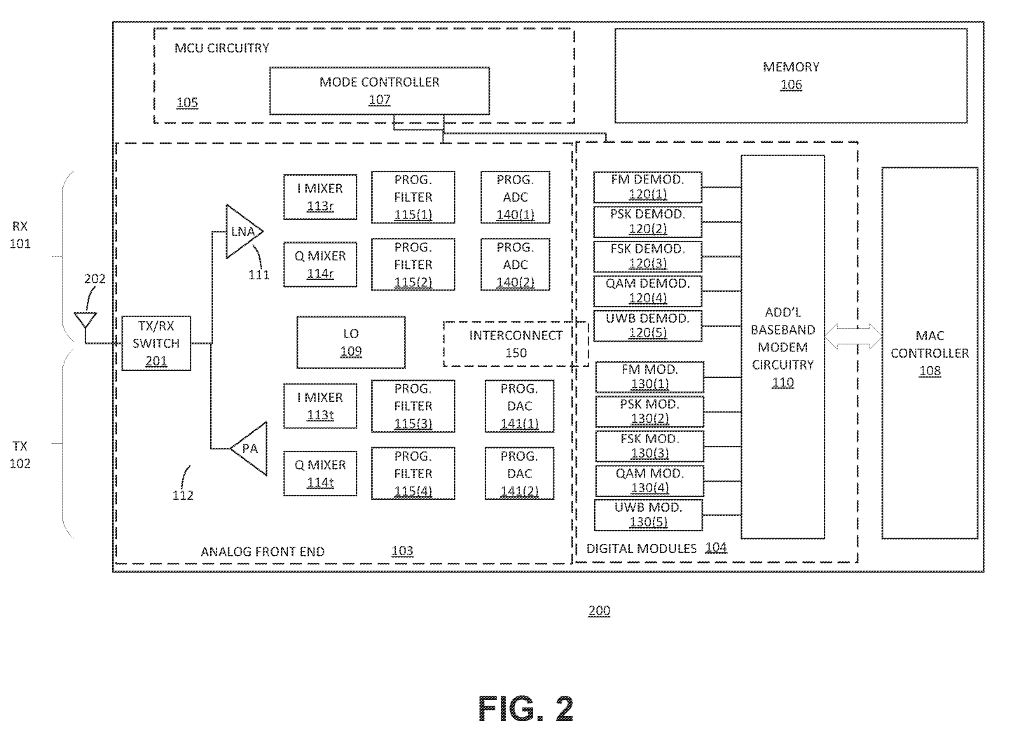

FIG. 2 illustrates a simplified schematic of an example implementation of an IC device 200 in accordance with an alternative embodiment of the disclosure. The IC device 200 is substantially similar to the IC device 100 of FIG. 1, but uses a single shared antenna 202, rather than two antennas as in IC device 100. The antenna 202 is configured to selectively connect to the LNA 111 and the PA 112 via TX/RX switch 201, which is controlled by the MCU circuitry 105. The MCU circuitry controls the TX/RX switch 201 to switch the antenna 202 between transmitting and receiving as needed. Accordingly, in IC device 200, the antenna 202 and the TX/RX switch 201 are also shared between the receive path 101 and the transmit path 102. It should be noted that devices 100 and 200 may be implemented on the same device; namely, a single device may have both multiple antennas and a TX/RX switch, where the device may be configured to use dedicated transmit and receive antennas or, alternatively, use a shared transceiver antenna.

It should be noted that IC devices in accordance with embodiments of the disclosure, such as, for example, SoC 100 of FIG. 1 and SoC 200 of FIG. 2 may be configured to use various additional components along their receive path 101 and/or transmit path 102. For example, various additional filters may be used between components in order to ensure that the corresponding signals remain within expected frequency bands and that signal components in unwanted frequency bands are suppressed. It should be further noted that embodiments of the disclosure may include additional reconfigurable transmit and receive components (not shown) to implement additional features or technologies.

The local oscillator module 109 may comprise one or more reconfigurable voltage-controlled oscillators configured to provide oscillating signals in different frequency ranges. The LO module 109 may include additional reconfigurable circuitry such as, for example, frequency dividers or phase-lock-loop (PLL) circuits to modify and control the frequency generated by any of the constituent oscillators. The local oscillator module 109 may also comprise a plurality of oscillators that vary in their power usage. In other words, the LO module 109 may comprise a low-power oscillator, a high-power oscillator, and any number of intermediate-power oscillators. For example, in a low-power mode, the LO module 109 may have an injection lock ring oscillator selectively enabled. The particular LO module circuitry activated in any particular operational mode may be selected by the mode controller 107 in accordance with a selected operating mode. Components of the LO module 109 may be interconnected using interconnect 150 or a similar reconfigurable interconnect technology.

The mode controller 107 controls various operational aspects of the SoC 100, particularly of the components of the analog front end 103 and the digital modules 104. The mode controller 107 selectively enables and disables one or more of the components, sets operating parameters for one or more of the components, and selectively enables and disables connections between two or more of the components.

Specifically, the mode controller 107 selectively enables and disables one or more of the in-phase and quadrature mixers, the local oscillator module, the programmable filters, the programmable ADCs, the programmable DACs, the modulators, and the demodulators. The mode controller 107 also programs the operating parameters of one or more of the in-phase and quadrature mixers, the local oscillator module, the programmable filters, the programmable ADCs, the programmable DACs, the modulators, and the demodulators. In addition, the controller is configured to configure the interconnect 150, for example, selectively enabling and disabling connections between two or more of the in-phase and quadrature mixers, the local oscillator, the programmable filters, the programmable ADCs, the programmable DACs, the modulators, and the demodulators. In general, the interconnect 150 is configured to selectively connect among components of the device 100 to form a signal path from an antenna to the MAC controller 108.

The mode controller 107 may selectively enable or disable a particular component by, for example, controlling a switch (e.g., a transistor, a logic gate, or a demultiplexer) (not shown) that provides power or a clock signal to the component. The mode controller 107 may selectively enable and disable the connections using at least one of multiplexers, demultiplexers, crossbar switches, switch matrices, and controllable interconnect fabric. The mode controller 107 may program the operating parameters of components in accordance with the programmability of the particular component. For example, various components may have selectable power levels to allow for low-power or regular operation. The programmable filters 115 may have digitally selectable capacitor banks to set properties like frequency ranges to pass and suppress, corner frequencies, and the like. Additional filters that may be used (not shown) may be similarly programmed. The programmable ADCs 140 and DACs 141 may have programmable sampling rates, which impact power usage and accuracy. The local oscillator 109 may have an output frequency digitally controlled as well as particular sub-components selectively enabled or disabled.

The plurality of operating modes selectable by the mode controller 107 includes two or more of Bluetooth (BT), Bluetooth Low Energy (BLE), Ultra Wide Band (UWB), Zigbee 802.15.4, and low power. The mode controller 107 may use a lookup table (not shown) to store and manage the programming parameters corresponding to each operating mode, where a table entry corresponds to a selected operating mode and indicates the enabled status and programming parameters of corresponding components, as well as the enabled status of corresponding interconnects. The lookup table, or a copy, may be stored in the memory 106 and may be intermittently updated by, for example, an update of the SoC 100 or SoC 200 (e.g., by an over the air (OTA) update) that adds, deletes, or modifies operating modes. The mode controller 107 may be configured to dynamically switch between operating modes of the plurality of operating modes—for example, in response to a received external request or in response to an internal determination by the MCU circuitry 105. It should be noted that in some alternative implementations, the SoC lacks a mode controller and the operational mode and components may be configured by an external controller temporarily connected to the SoC device.

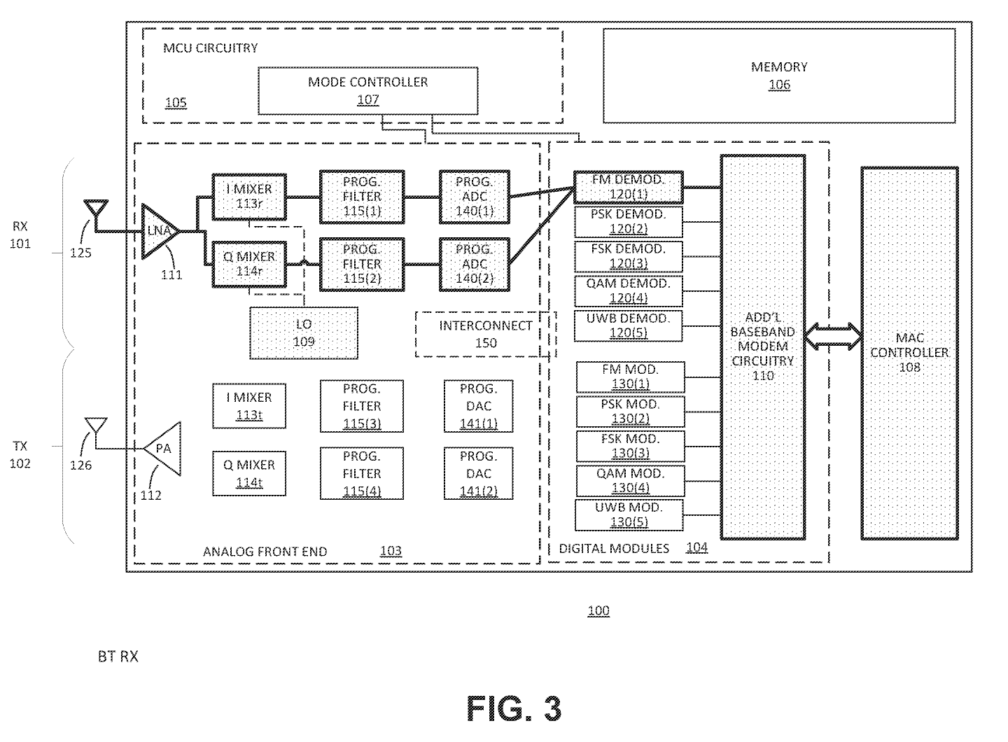

FIG. 3 shows the SoC 100 of FIG. 1 operating in a Bluetooth receive operating mode. Components along the receive path 101 that are enabled are shown in bold outlines and with a dotted fill. Enabled interconnects are shown in bold. Specifically, antenna 125, LNA 111, LO module 109, I-mixer 113r, Q-mixer 114r, programmable filters 115(1) and 115(2), programmable ADCs 140(1) and 140(2), FM demodulator 120(1), additional baseband circuitry 110, and MAC controller 108 are enabled, as are the corresponding signal interconnects from the antenna 125 to the MAC controller 108. Other components of the receive path 101, as well as the components of the transmit path 102, may be disabled or in a low-power mode.

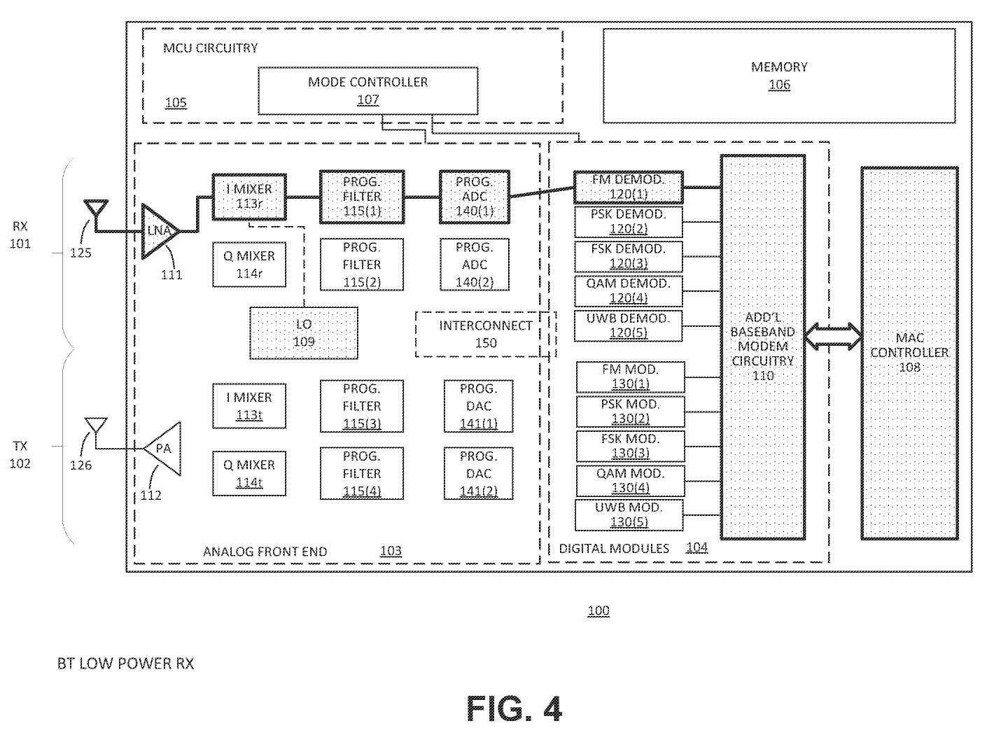

FIG. 4 shows the SoC 100 of FIG. 1 operating in a Bluetooth low-power receive operating mode. Components along the receive path 101 that are enabled are shown in bold outlines and with a dotted fill. Enabled interconnects are shown in bold. Specifically, antenna 125, LNA 111, LO module 109, I-mixer 113r, programmable filter 115(1), programmable ADC 140(1), FM demodulator 120(1), additional baseband circuitry 110, and MAC controller 108 are enabled, as are the corresponding signal interconnects from the antenna 125 to the MAC controller 108. Other components of the receive path 101, as well as the components of the transmit path 102, may be disabled or in a low-power mode. LO module 109 may also be programmed to operate in a low-power mode. This operational mode may be used, for example, to implement a low-power wake-up feature. Note that, in some alternative implementations, a low-power wake-up feature may be implemented using alternative components (not shown) such as, for example, a 1-bit ADC instead of a programmable ADC 140, configured to connected between the antenna 125 and the corresponding demodulator 120.

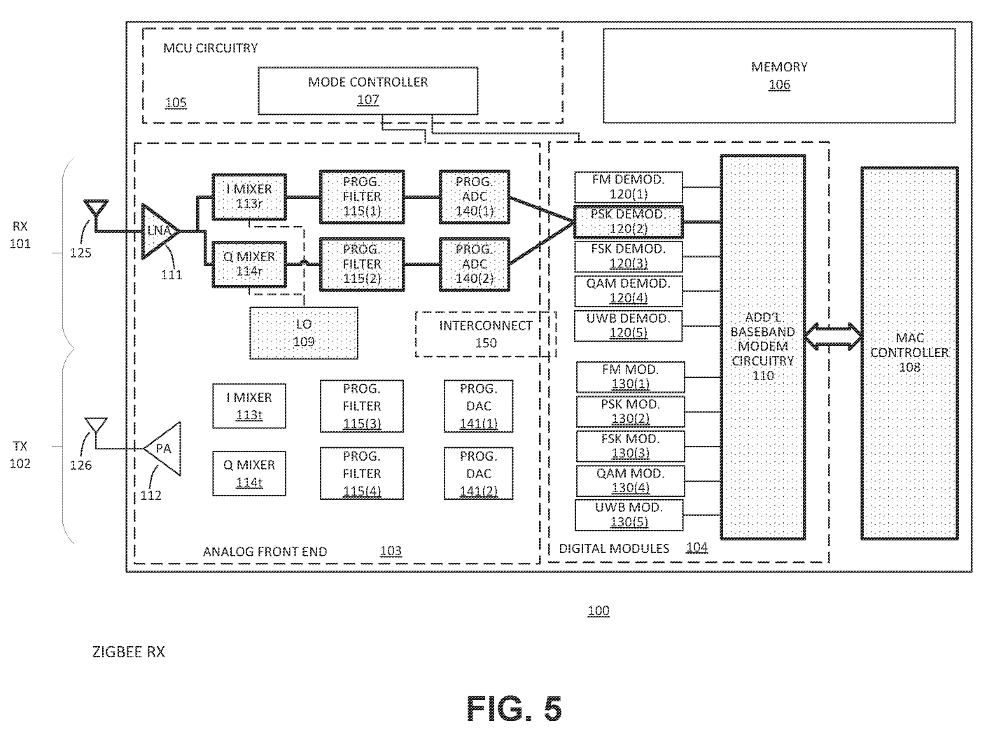

FIG. 5 shows the SoC 100 of FIG. 1 operating in a Zigbee 802.15.4 receive operating mode. Components along the receive path 101 that are enabled are shown in bold outlines and with a dotted fill. Enabled interconnects are shown in bold. Specifically, antenna 125, LNA 111, LO module 109, I-mixer 113r, Q-mixer 114r, programmable filters 115(1) and 115(2), programmable ADCs 140(1) and 140(2), PSK demodulator 120(2), additional baseband circuitry 110, and MAC controller 108 are enabled, as are the corresponding signal interconnects from the antenna 125 to the MAC controller 108. Other components of the receive path 101, as well as the components of the transmit path 102, may be disabled or in a low-power mode.

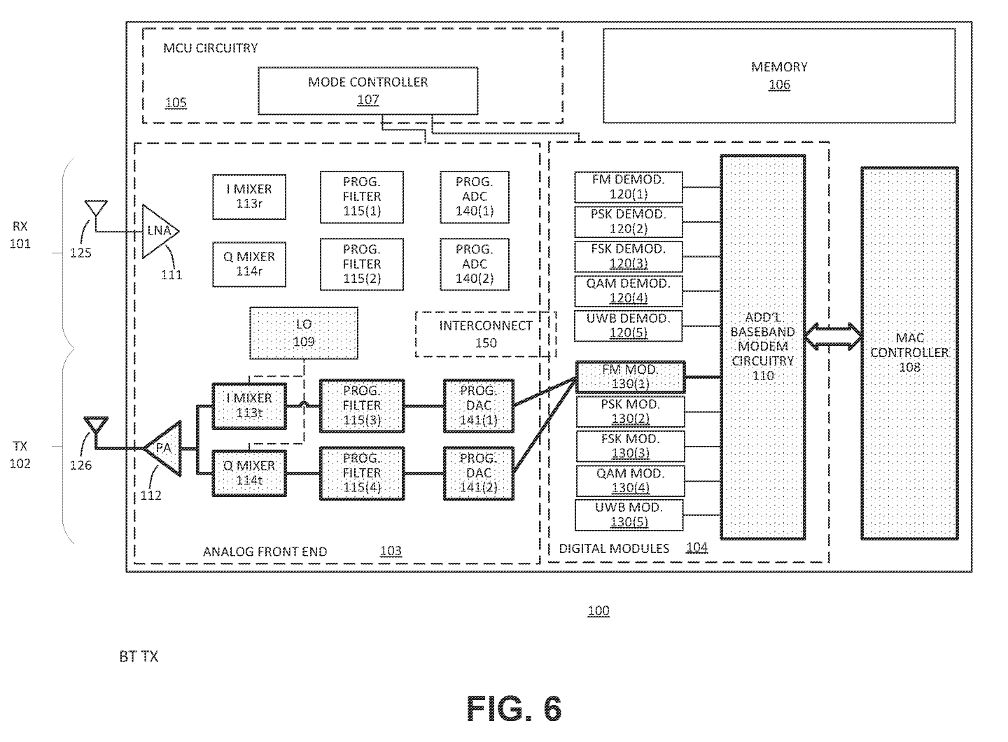

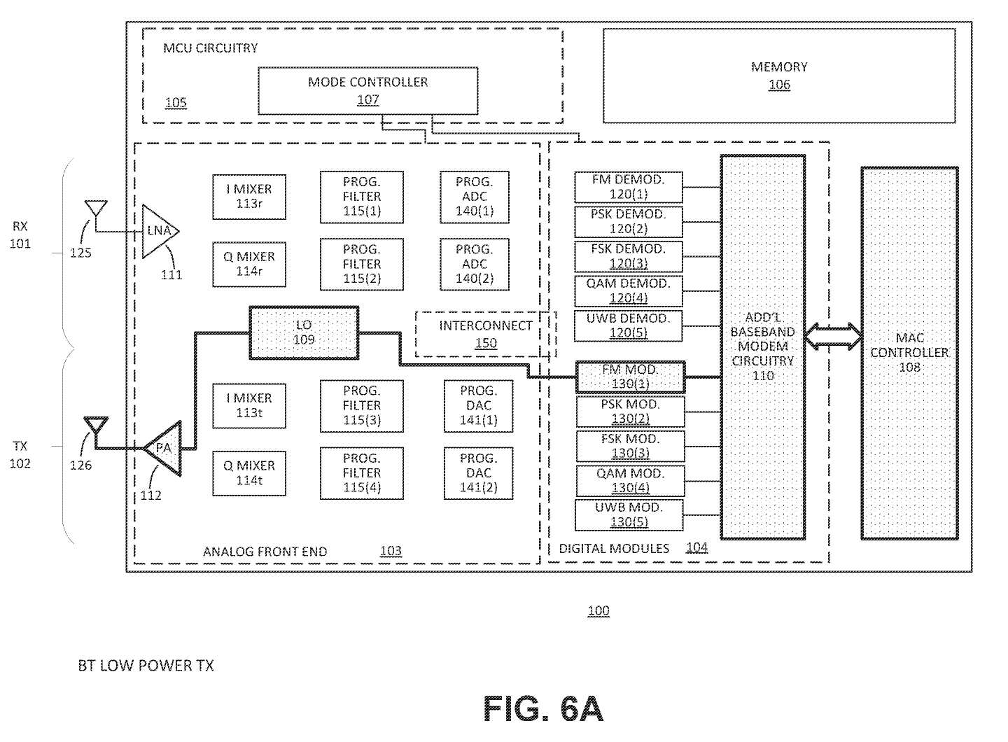

FIG. 6 shows the SoC 100 of FIG. 1 operating in a Bluetooth transmit operating mode. Components along the transmit path 102 that are enabled are shown in bold outlines and with a dotted fill. Enabled interconnects are shown in bold. Specifically, MAC controller 108, additional baseband circuitry 110, FM modulator 130(1), programmable DACs 141(1) and 141(2), programmable filters 115(3) and 115(4), I-mixer 113t, Q-mixer 114t, PA 112, and antenna 126 are enabled, as are the corresponding signal interconnects from the MAC controller 108 to the antenna 126. Other components of the transmit path 102, as well as the components of the receive path 101, may be disabled or in a low-power mode.

FIG. 6A shows the SoC 100 of FIG. 1 operating in a Bluetooth low-power transmit operating mode. Components along the transmit path 102 that are enabled are shown in bold outlines and with a dotted fill. Enabled interconnects are shown in bold. Specifically, MAC controller 108, additional baseband circuitry 110, FM modulator 130(1), LO module 109, PA 112, and antenna 126 are enabled, as are the corresponding signal interconnects from the MAC controller 108 to the antenna 126. Other components of the transmit path 102, as well as the components of the receive path 101, may be disabled or in a low-power mode. LO module 109 may also be programmed to operate in a low-power mode.

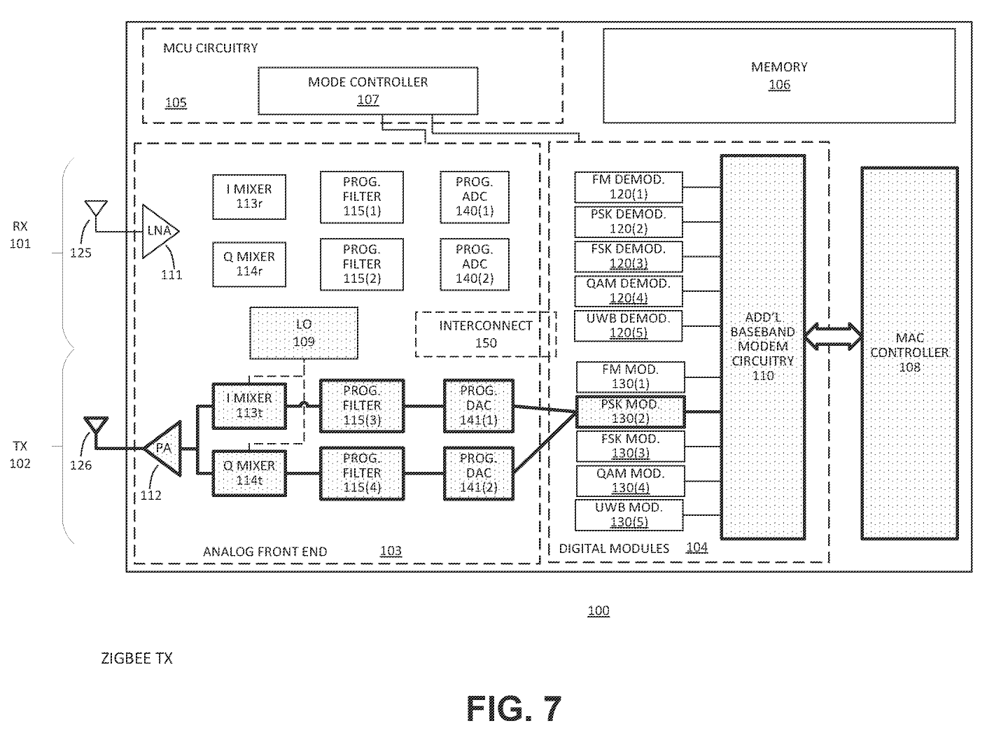

FIG. 7 shows the SoC 100 of FIG. 1 operating in a Zigbee 802.15.4 transmit operating mode. Components along the transmit path 102 that are enabled are shown in bold outlines and with a dotted fill. Enabled interconnects are shown in bold. Specifically, MAC controller 108, additional baseband circuitry 110, PSK modulator 130(2), programmable DACs 141(1) and 141(2), programmable filters 115(3) and 115(4), I-mixer 113t, Q-mixer 114t, PA 112, and antenna 126 are enabled, as are the corresponding signal interconnects from the MAC controller 108 to the antenna 126. Other components of the transmit path 102, as well as the components of the receive path 101, are disabled or in a low-power mode. It should be noted that the SoC 200 of FIG. 2 would operate substantially the same in the above-described example operating modes, with suitable changes – namely, enabling, programming, and using the TX/RX switch 201 and the antenna 202 and corresponding interconnects, instead of antennas 125 or 126.

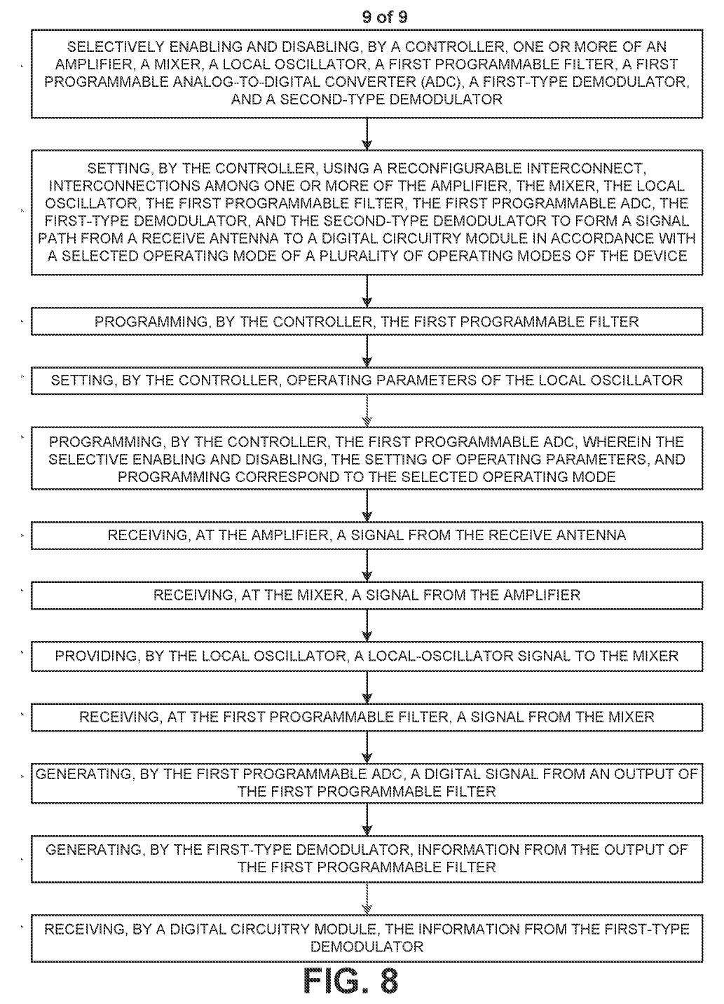

FIG. 8 shows a flowchart for an example procedure 800 for embodiments of the disclosure, such as, for example, SoC devices 100 and 200. The procedure 800 starts with selectively enabling and disabling, by a controller, one or more of an amplifier, a mixer, a local oscillator, a first programmable filter, a first programmable analog-to-digital converter (ADC), a first-type demodulator, and a second-type demodulator (step 801), and setting, by the controller, using a reconfigurable interconnect, interconnections among one or more of the amplifier, the mixer, the local oscillator, the first programmable filter, the first programmable ADC, the first-type demodulator, and the second-type demodulator to form a signal path from a receive antenna to a digital circuitry module in accordance with a selected operating mode of a plurality of operating modes of the device (step 802). The example procedure 800 may further include programming, by the controller, the first programmable filter (step 803), setting, by the controller, operating parameters of the local oscillator (step 804) and programming, by the controller, the first programmable ADC, wherein the selective enabling and disabling, the setting of operating parameters, and programming correspond to the selected operating mode (step 805). This is followed by receiving, at the amplifier, a signal from the receive antenna (step 806) as well as receiving, at the mixer, a signal from the amplifier (step 807). Next, is providing, by the local oscillator, a local-oscillator signal to the mixer (step 808). That is followed by receiving, at the first programmable filter, a signal from the mixer (step 809). Next is generating, by the first programmable ADC, a digital signal from an output of the first programmable filter (step 810) and generating, by the first-type demodulator, information from the output of the first programmable filter (step 811). Then the procedure 800 continues with receiving, by a digital circuitry module, the information from the first-type demodulator (step 812).

It should be noted that the steps do not have to be performed in the ordered described and certain steps may be performed in parallel, out of order, or in different iterations. For example, generally, only one type demodulator is used in a particular mode and, so, the second-type demodulator described (e.g., step 802) would be used in a different execution of the procedure 800 using a different operating mode. Additionally, systems in accordance with the disclosure may skip certain steps in some circumstances.

While embodiments have been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations.

Examples can include subject matter such as a method, means for performing acts or blocks of the method, at least one machine-readable medium including instructions that, when performed by a machine cause the machine to perform acts of the method or of an apparatus or system for detecting a non-transmitting target according to embodiments and examples described herein.

Example 1 is a multi-mode wireless-communication integrated circuit (IC) device including: an amplifier configured to connect to a receive antenna, a mixer, a local oscillator having programmable operating parameters, a first programmable filter, a first programmable analog-to-digital converter (ADC). a first-type demodulator, a second-type demodulator, a digital circuitry module configured to receive information from the first-type and second-type demodulators, and a reconfigurable interconnect. The reconfigurable interconnect is configured to selectively connect among one or more of the amplifier, the mixer, the local oscillator, the first programmable filter, the first programmable ADC, the first-type demodulator, and the second-type demodulator to form a signal path from the receive antenna to the digital circuitry module in accordance with a selected operating mode of a plurality of operating modes of the device.

Example 2 includes the subject matter of example 1, including or omitting optional elements, wherein: the reconfigurable interconnect is configured to connect the amplifier to the first-type demodulator, bypassing any mixer, programmable filter, and programmable ADC.

Example 3 includes the subject matter of any of examples 1-2, including or omitting optional elements, wherein the reconfigurable interconnect is configured to: connect the mixer to the receive an output of the amplifier, connect the first programmable filter to receive an output of the mixer, connect the first programmable ADC to receive an output of the first programmable filter, and connect the first-type demodulator to receive an output of the first programmable ADC.

Example 4 includes the subject matter of any of examples 1-3, including or omitting optional elements, wherein the amplifier is a low-noise amplifier (LNA), the mixer comprises an in-phase mixer and a quadrature mixer, and the local oscillator is configured to provide corresponding local-oscillator signals to the in-phase mixer and the quadrature mixer.

Example 5 includes the subject matter of any of examples 1-4, including or omitting optional elements, wherein the plurality of operating modes includes two or more of Bluetooth (BT), Bluetooth Low Energy (BLE), Ultra-Wide Band (UWB), 802.15.4, and low power.

Example 6 includes the subject matter of any of examples 1-5, including or omitting optional elements, wherein the device comprises a look-up table and the parameters for the plurality of operating modes are stored in the look-up table.

Example 7 includes the subject matter of any of examples 1-6, including or omitting optional elements, wherein the device includes a controller configured to control the reconfigurable interconnect and the controller is configured to modify the plurality of operating modes.

Example 8 includes the subject matter of any of examples 1-7, including or omitting optional elements, wherein the reconfigurable interconnect is configured to dynamically switch between operating modes of the plurality of operating modes.

Example 9 includes the subject matter of any of examples 1-8, including or omitting optional elements, wherein each of the first-type and second-type demodulators employs one of: frequency modulation (FM), frequency-shift keying (FSK), phase-shift keying (PSK), binary PSK (BPSK), differential PSK (DPSK), quadrature PSK (QPSK), offset QPSK (OQPSK), orthogonal frequency-division multiplexing (OFDM), and quadrature amplitude modulation (QAM).

Example 10 includes the subject matter of any of examples 1-9, including or omitting optional elements, further including: a power amplifier (PA) configured to connect to a transmission antenna, a second mixer, a second programmable filter, a first programmable digital to analog converter (DAC), a first-type modulator, and a second-type modulator. The digital circuitry module is configured to provide information to the first-type and second-type modulators. The reconfigurable interconnect is configured to selectively connect among one or more of the PA, the second mixer, the local oscillator, the second programmable filter, the first programmable DAC, the first-type modulator, and the second-type modulator to form a signal path from the digital circuitry module to the transmission antenna in accordance with a selected operating mode of the plurality of operating modes of the device.

Example 11 includes the subject matter of example 10, including or omitting optional elements, wherein the transmission antenna is also the receive antenna and the amplifier and the PA connect to the receive antenna via a transmit/receive switch.

Example 12 is a multi-mode wireless-communication integrated circuit (IC) device including: a power amplifier (PA) configured to connect to a transmission antenna, a mixer, a transmission quadrature mixer configured to connect to the PA, a local oscillator having programmable operating parameters, a first programmable filter, a first programmable digital to analog converter (DAC), a first-type modulator, a second-type modulator, a digital circuitry module configured to provide information to the first-type and second-type modulators, and a reconfigurable interconnect configured to selectively connect among one or more of the PA, the mixer, the local oscillator, the first programmable filter, the first programmable DAC, the first-type modulator, and the second-type modulator to form a signal path from the digital circuitry module to the transmission antenna in accordance with a selected operating mode of a plurality of operating modes of the device.

Example 13 is a method for a multi-mode wireless-communication integrated circuit (IC) device, the method including: selectively enabling and disabling, by a controller, one or more of an amplifier, a mixer, a local oscillator, a first programmable filter, a first programmable analog-to-digital converter (ADC), a first-type demodulator, and a second-type demodulator, and setting, by the controller, using a reconfigurable interconnect, interconnections among one or more of the amplifier, the mixer, the local oscillator, the first programmable filter, the first programmable ADC, the first-type demodulator, and the second-type demodulator to form a signal path from a receive antenna to a digital circuitry module in accordance with a selected operating mode of a plurality of operating modes of the device.

Example 14 includes the subject matter of example 13, including or omitting optional elements, further including programming, by the controller, the first programmable filter, setting, by the controller, operating parameters of the local oscillator, programming, by the controller, the first programmable ADC, wherein the selective enabling and disabling, the setting of operating parameters, and programming correspond to the selected operating mode, receiving, at the amplifier, a signal from the receive antenna, receiving, at the mixer, a signal from the amplifier, providing, by the local oscillator, a local-oscillator signal to the mixer, receiving, at the first programmable filter, a signal from the mixer, generating, by the first programmable ADC, a digital signal from an output of the first programmable filter, generating, by the first-type demodulator, information from the output of the first programmable filter, and receiving, by a digital circuitry module, the information from the first-type demodulator.

Example 15 includes the subject matter of any of examples 13-14, including or omitting optional elements, wherein setting the interconnections comprises connecting the amplifier to the first-type demodulator, bypassing any mixer, programmable filter, and programmable ADC.

Example 16 includes the subject matter of any of examples 13-15, including or omitting optional elements, wherein setting the interconnections includes: connecting the mixer to the receive an output of the amplifier, connecting the first programmable filter to receive an output of the mixer, connecting the first programmable ADC to receive an output of the first programmable filter, and connecting the first-type demodulator to receive an output of the first programmable ADC.

Example 17 includes the subject matter of any of examples 13-16, including or omitting optional elements, further including storing parameters for the plurality of operating modes in a look-up table.

Example 18 includes the subject matter of any of examples 13-17, including or omitting optional elements, further including updating, by the controller, the plurality of operating modes.

Example 19 includes the subject matter of any of examples 13-18, including or omitting optional elements, further including dynamically switching, by the controller, between operating modes of the plurality of operating modes.

Example 20 includes the subject matter of any of examples 13-19, including or omitting optional elements, wherein each of the first-type and second-type demodulators employs one of: frequency modulation (FM), frequency-shift keying (FSK), phase-shift keying (PSK), binary PSK (BPSK), differential PSK (DPSK), quadrature PSK (QPSK), offset QPSK (OQPSK), orthogonal frequency-division multiplexing (OFDM), and quadrature amplitude modulation (QAM).

The foregoing description of one or more implementations provides illustration and description, but is not intended to be exhaustive or to limit the scope of the example embodiments to the precise form disclosed. Modifications and variations are possible in light of the above teachings or may be acquired from practice of various implementations of the example embodiments.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In the present disclosure like reference numerals are used to refer to like elements throughout, and wherein the illustrated structures and devices are not necessarily drawn to scale.

As utilized herein, terms “module”, “component,” “system,” “circuit,” “circuitry,” “element,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

It will be understood that when an element is referred to as being “electrically connected” or “electrically coupled” to another element, it can be physically connected or coupled to the other element such that current and/or electromagnetic radiation can flow along a conductive path formed by the elements. Intervening conductive, inductive, or capacitive elements may be present between the element and the other element when the elements are described as being electrically coupled or connected to one another. Further, when electrically coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

What is claimed is:

1. A multi-mode wireless-communication integrated circuit (IC) device comprising:
an amplifier configured to connect to a receive antenna;
a mixer;
a local oscillator having programmable operating parameters;
a first programmable filter;
a first programmable analog-to-digital converter (ADC);
a first-type demodulator;
a second-type demodulator;
a digital circuitry module configured to receive information from the first-type and second-type demodulators; and
a reconfigurable interconnect, wherein:
the reconfigurable interconnect is configured to selectively connect among one or more of the amplifier, the mixer, the local oscillator, the first programmable filter, the first programmable ADC, the first-type demodulator, and the second-type demodulator to form a signal path from the receive antenna to the digital circuitry module in accordance with a selected operating mode of a plurality of operating modes of the device.

2. The device of claim 1, wherein the reconfigurable interconnect is configured to connect the amplifier to the first-type demodulator, bypassing any mixer, programmable filter, and programmable ADC.

3. The device of claim 1, wherein the reconfigurable interconnect is configured to:
connect the mixer to receive an output of the amplifier;
connect the first programmable filter to receive an output of the mixer;
connect the first programmable ADC to receive an output of the first programmable filter; and
connect the first-type demodulator to receive an output of the first programmable ADC.

4. The device of claim 1, wherein:
the amplifier is a low-noise amplifier (LNA);
the mixer comprises an in-phase mixer and a quadrature mixer; and
the local oscillator is configured to provide corresponding local-oscillator signals to the in-phase mixer and the quadrature mixer.

5. The device of claim 1, wherein the plurality of operating modes includes two or more of Bluetooth (BT), Bluetooth Low Energy (BLE), Ultra Wide Band (UWB), Zigbee, and low power.

6. The device of claim 1, wherein:
the device comprises a look-up table; and
parameters for the plurality of operating modes are stored in the look-up table.

7. The device of claim 1, wherein:
the device comprises a controller configured to control the reconfigurable interconnect; and
the controller is configured to modify the plurality of operating modes.

8. The device of claim 1, wherein the reconfigurable interconnect is configured to dynamically switch between operating modes of the plurality of operating modes.

9. The device of claim 1, wherein each of the first-type and second-type demodulators employs one of: frequency modulation (FM), frequency-shift keying (FSK), phase-shift keying (PSK), binary PSK (BPSK), differential PSK (DPSK), quadrature PSK (QPSK), offset QPSK (OQPSK), orthogonal frequency-division multiplexing (OFDM), and quadrature amplitude modulation (QAM).

10. The device of claim 1, further comprising:
a power amplifier (PA) configured to connect to a transmission antenna;
a second mixer;
a second programmable filter;
a first programmable digital to analog converter (DAC);
a first-type modulator; and
a second-type modulator, wherein:
the digital circuitry module is configured to provide information to the first-type and second-type modulators; and
the reconfigurable interconnect is configured to selectively connect among one or more of the PA, the second mixer, the local oscillator, the second programmable filter, the first programmable DAC, the first-type modulator, and the second-type modulator to form a signal path from the digital circuitry module to the transmission antenna in accordance with a selected operating mode of the plurality of operating modes of the device.

11. The device of claim 10, wherein:
the transmission antenna is also the receive antenna; and
the amplifier and the PA connect to the receive antenna via a transmit/receive switch.

12. A multi-mode wireless-communication integrated circuit (IC) device comprising:
a power amplifier (PA) configured to connect to a transmission antenna;
a mixer;
a transmission quadrature mixer configured to connect to the PA;
a local oscillator having programmable operating parameters;
a first programmable filter;
a first programmable digital to analog converter (DAC);
a first-type modulator;
a second-type modulator;
a digital circuitry module configured to provide information to the first-type and second-type modulators; and
a reconfigurable interconnect configured to selectively connect among one or more of the PA, the mixer, the local oscillator, the first programmable filter, the first programmable DAC, the first-type modulator, and the second-type modulator to form a signal path from the digital circuitry module to the transmission antenna in accordance with a selected operating mode of a plurality of operating modes of the device.

13. A method for a multi-mode wireless-communication integrated circuit (IC) device, the method comprising:
selectively enabling and disabling, by a controller, one or more of an amplifier, a mixer, a local oscillator, a first programmable filter, a first programmable analog-to-digital converter (ADC), a first-type demodulator, and a second-type demodulator; and
setting, by the controller, using a reconfigurable interconnect, interconnections among one or more of the amplifier, the mixer, the local oscillator, the first programmable filter, the first programmable ADC, the first-type demodulator, and the second-type demodulator to form a signal path from a receive antenna to a digital circuitry module in accordance with a selected operating mode of a plurality of operating modes of the device.

14. The method of claim 13, further comprising:
programming, by the controller, the first programmable filter;
setting, by the controller, operating parameters of the local oscillator;
programming, by the controller, the first programmable ADC, wherein the selective enabling and disabling, the setting of operating parameters, and programming correspond to the selected operating mode;
receiving, at the amplifier, a signal from the receive antenna;
receiving, at the mixer, a signal from the amplifier;
providing, by the local oscillator, a local-oscillator signal to the mixer;
receiving, at the first programmable filter, a signal from the mixer;
generating, by the first programmable ADC, a digital signal from an output of the first programmable filter;
generating, by the first-type demodulator, information from the output of the first programmable filter; and
receiving, by a digital circuitry module, the information from the first-type demodulator.

15. The method of claim 13, wherein setting the interconnections comprises connecting the amplifier to the first-type demodulator, bypassing any mixer, programmable filter, and programmable ADC.

16. The method of claim 13, wherein setting the interconnections comprises:
connecting the mixer to receive an output of the amplifier;
connecting the first programmable filter to receive an output of the mixer;
connecting the first programmable ADC to receive an output of the first programmable filter; and
connecting the first-type demodulator to receive an output of the first programmable ADC.

17. The method of claim 13, further comprising storing parameters for the plurality of operating modes in a look-up table.

18. The method of claim 13, further comprising updating, by the controller, the plurality of operating modes.

19. The method of claim 13, further comprising dynamically switching, by the controller, between operating modes of the plurality of operating modes.

20. The method of claim 13, wherein each of the first-type and second-type demodulators employs one of: frequency modulation (FM), frequency-shift keying (FSK), phase-shift keying (PSK), binary PSK (BPSK), differential PSK (DPSK), quadrature PSK (QPSK), offset QPSK (OQPSK), orthogonal frequency-division multiplexing (OFDM), and quadrature amplitude modulation (QAM).
